(19) United States
(12) Patent Application Publication
(10) Pub. No.: US 2024/0334914 A1
(43) Pub. Date: Oct. 10, 2024

(54) HONEYBEE FRAME COMB MAKER

(71) Applicant: James Milton Romano, Hamilton, NJ (US)

(72) Inventor: James Milton Romano, Hamilton, NJ (US)

(21) Appl. No.: 18/629,425

(22) Filed: Apr. 8, 2024

Related U.S. Application Data
(60) Provisional application No. 63/458,093, filed on Apr. 8, 2023.

(51) Int. Cl. A01K 47/04

(52) U.S. Cl. CPC A01K 47/04

(57) ABSTRACT

A comb forming device comprising a pair of plates of having substantially similar outer dimensions and having respective inner and outer surfaces, wherein the inner surfaces of the plates have formed thereon corresponding octagon shaped protrusions of one or more selected sizes; and a closure mechanism for holding the plates together in an operative position, the operative position comprising the plates compressing therebetween a frame; at least one of the plates having one or more first apertures configured to receive therethrough melted wax to be conveyed to a space formed between the plates in the operative position; at least one of the plates having one or more second apertures configured to enable a vacuum pump attached thereto to remove therethrough air from the space formed between the plates in the operative position, the vacuum pressure configured to urge the distribution of was throughout the space formed between the plates and in accordance with the octagon shaped protrusions of the inner surfaces of the plates to form thereby a comb structure.

### CROSS-REFERENCE TO RELATED APPLICATION

This application claims the benefit of provisional patent application Ser. No. 63/458,093 filed on Apr. 8, 2023, entitled HONEYBEE FRAME COMB MAKER), which provisional patent application is incorporated herein by reference in its entirety.

### FIELD OF THE DISCLOSURE

The present disclosure generally relates to a honeybee frame comb maker.

### BACKGROUND

Honeybees make honey at commercial scale for the honey industry, which provides hive structures including frames which the honeybees use to build combs from wax. The combs are used to store pollen and honey for use by the hive and for their larva and eggs stored within the comb structure. To make one pound of wax the honeybees must eat up to 8-pounds of honey.

### SUMMARY OF THE INVENTION

Various deficiencies in the prior art are addressed below by apparatus and methods suitable for use in efficiently generating honeycomb structures.

A comb forming device according to an embodiment may comprise: a pair of plates of having substantially similar outer dimensions and having respective inner and outer surfaces, wherein the inner surfaces of the plates have formed thereon corresponding octagon shaped protrusions of one or more selected sizes; and a closure mechanism for holding the plates together in an operative position, the operative position comprising the plates compressing therebetween a frame; at least one of the plates having one or more first apertures configured to receive therethrough melted wax to be conveyed to a space formed between the plates in the operative position; at least one of the plates having one or more second apertures configured to enable a vacuum pump attached thereto to remove therethrough air from the space formed between the plates in the operative position, the vacuum pressure configured to urge the distribution of was throughout the space formed between the plates and in accordance with the octagon shaped protrusions of the inner surfaces of the plates to form thereby a comb structure.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 depicts a system according to embodiment; and

FIG. 2 depicts a pair of plates suitable for use in the system of FIG. 1.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art and are to be construed as being without limitation to such specifically recited examples and conditions. Additionally, the term, “or” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

Various deficiencies in the prior art are addressed below by apparatus and methods suitable for use in efficiently generating honeycomb structures. A honeycomb or comb is a structure comprising a number of honeycomb cells built from wax by honeybees and used to store honeybee eggs, honey, and so on. The honeybees within the hive perform various duties with respect to the hive, including gathering pollen, making honey, and storing honey in cells within the comb.

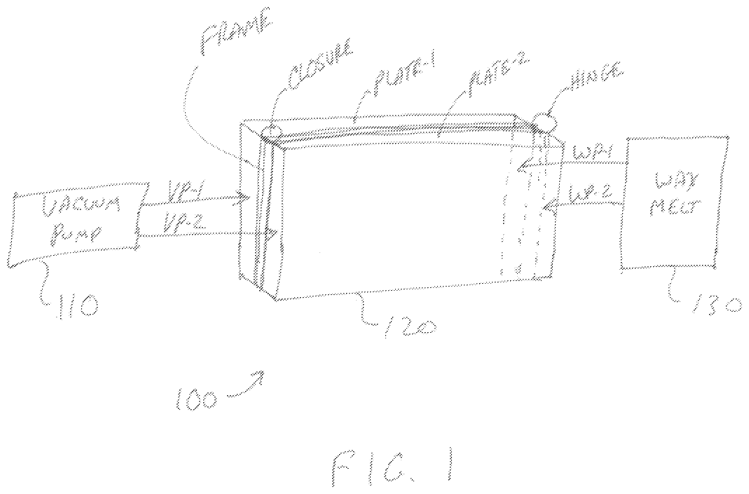

FIG. 1 depicts a system according to embodiment. Specifically, the system 100 of FIG. 1 comprises a vacuum pump 110, a comb forming device 120, and a source of melted wax 130.

The comb forming device 120 comprises a pair of template plates or “plates” denoted as PLATE-1 and PLATE-2, each of the plates having substantially similar outer dimensions and respective inner and outer surfaces, wherein the inner surfaces of the plates have formed thereon octagon shaped protrusions of one or more sizes selected in accordance with appropriate comb cell sizes. The comb forming device 120 is configured to receive a blank frame FRAME which will be compressed between the plates PLATE-1 and PLATE-2 during operation thereof, such that a comb is formed within the frame FRAME.

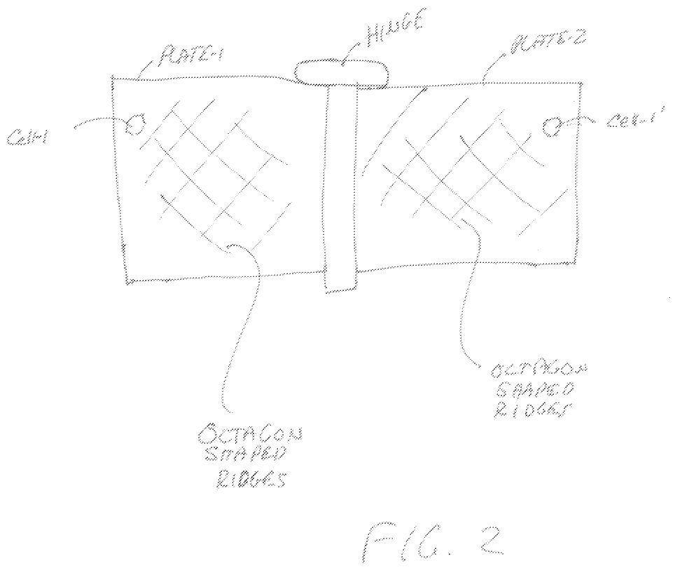

The comb forming device 120 further comprises a closure mechanism for holding the plates PLATE-1 and PLATE-2 together, such as one or more hinges, clamps, clasps, bolts, or other mechanical means which are illustratively represented in FIG. 1 as a hinge mechanism HINGE and a closure mechanism CLOSURE. That is, the plates PLATE-1 and PLATE-2 are coupled together on one common edge via a hinge mechanism HINGE, about which the plates PLATE-1 and PLATE-2 may be rotated from an open position (as depicted in FIG. 2) to a closed position (as depicted din FIG. 1), wherein the inner surfaces of each of the plates PLATE-1 and PLATE-2 are brought into planar proximity with each other when the comb forming device 120 is in a “closed” or operative position. The plates PLATE-1 and PLATE-2 are held in this position by the hinge HINGE on a first edge of the plates PLATE-1 and PLATE-2 and a closure CLOSURE on a second edge of the plates PLATE-1 and PLATE-2.

The closure CLOSURE may comprise any suitable means for securing the plates PLATE-1 and PLATE-2 in a closed or operative position (e.g., a clamping mechanism, bolt mechanism, and so on). As depicted in FIGS. 1-2, the plates PLATE-1 and PLATE-2 are substantially rectangular in shape, and the first and second edges of the plates PLATE-1 and PLATE-2 are opposite each other. In various embodiments, both the hinge HINGE and closure CLOSURE comprise the same type of clamping or bolt mechanisms.

The octagon shaped protrusions or ridges formed on the inner surface of the first plate PLATE-1 align with corresponding octagon shaped protrusions or ridges formed on the inner surface of the second plate PLATE-2.

The octagon shaped protrusions or ridges formed on the inner surfaces of the plates PLATE-1 and PLATE-2 are aligned but not touching each other, thereby leaving space between the inner surfaces of the plates and the octagon shaped protrusions or ridges formed thereon for melted wax to flow and form octagon comb cells. Referring to FIG. 2, it is noted that a cell denoted as CELL-1 formed upon the inner surface of the first plate PLATE-1 corresponds to an mechanically cooperates with a cell denoted as CELL-1′ formed upon the inner surface of the second plate PLATE-2 when the comb forming device 120 is in the operative or closed position. Optionally, each of the cells has associated with it a respective heater, such as HEATER-1 and HEATER-1′ as depicted in FIG. 2, the heaters being used to facilitate release of the comb from the plates PLATES after formation within the frame FRAME. In various embodiments, only some of the cells have a corresponding heater. In various embodiments, the heaters are large enough to heat some or even all of the cells at once.

As depicted in FIG. 1, the source of melted wax 130 (e.g., a wax heater with a wax reservoir) is operatively coupled or attached to one or both of the plates PLATE-1 and PLATE-2 and configured to introduce melted wax into the space between the inner surfaces of the plates PLATE-1 and PLATE-2 when the comb forming device 120 is in the closed or operative position depicted in FIG. 1. The was is urged from the source of melted wax 130 into the space between the inner surfaces of the plates PLATE-1 and PLATE-2 via the vacuum pump 110, which is attached to one or both of the plates PLATE-1 and PLATE-2 and configured to evacuate air from the space therebetween.

Specifically, at least one of the plates PLATE-1 and PLATE-2 has formed thereat (e.g., at a side(s) of the plate(s)) one or more first apertures configured to receive therethrough melted wax to be conveyed to a space formed between the plates in the operative position. Further, at least one of the plates PLATE-1 and PLATE-2 has formed thereat (e.g., at a side(s) of the plate(s)) one or more second apertures configured to enable a vacuum pump attached thereto (such as via one or more hoses) to remove therethrough air from the space formed between the plates in the operative position, the vacuum pressure configured to urge the distribution of was throughout the space formed between the plates and in accordance with the octagon shaped protrusions of the inner surfaces of the plates to form thereby a comb structure.

In a first operational step, hot melted wax from the source of melted wax 130 is drawn into the space between the inner surfaces of the plates PLATE-1 and PLATE-2 of the comb forming device 120 by negative pressure (vacuum) of that space induced by the vacuum pump 110.

In a second operational step, the melted wax is allowed to cool. The source of melted wax 130 may be disconnected, though the vacuum should be maintained for at least a portion of this step until the was has cooled enough to form a structurally sound comb.

In a third operational step, the comb forming device 120 is opened to release the comb structure formed therein. Honeybees may use this structure to quickly build a full comb when this structure is inserted into a hive on a frame.

Thus, a comb forming device according to an embodiment may comprise: a pair of plates of having substantially similar outer dimensions and having respective inner and outer surfaces, wherein the inner surfaces of the plates have formed thereon corresponding octagon shaped protrusions of one or more selected sizes; and a closure mechanism for holding the plates together in an operative position, the operative position comprising the plates compressing therebetween a frame; at least one of the plates having one or more first apertures configured to receive therethrough melted wax to be conveyed to a space formed between the plates in the operative position; at least one of the plates having one or more second apertures configured to enable a vacuum pump attached thereto to remove therethrough air from the space formed between the plates in the operative position, the vacuum pressure configured to urge the distribution of was throughout the space formed between the plates and in accordance with the octagon shaped protrusions of the inner surfaces of the plates to form thereby a comb structure.

The template plates PLATES described above are configured to reproduce more comb makers. Various different template plates may be used to provides comb cells having various comb sizes (e.g., drone bee cells are larger than worker bee cells). The material used for the plates should be strong and durable and easy for heat transfer; able to withstand the heat of melted wax yet allow for the cooled wax to detach from the material easily. Suitable materials comprise stainless steel, copper, aluminum, various high temperature plastics and so on.

In various embodiments, holes may be drilled in the template plate at locations where octagon shaped cell structures (protrusions or ridges) are to be is installed so as to enable accurate alignment of an octagon shaped cells. The ends of the octagon structures may also be rounded so as to enable easy and accurate welding into place. Further, low voltage wiring system inserted into the comb cell structures to enable brief but partial heating of the wax to enable easy extraction of the comb from the surface.

In some embodiments, each octagon shaped protrusion/ridge is ⅛″ to 3/16″ longer than needed depending on the thickness of the plates. The extra length on the back end of each octagon shaped protrusion/ridge is then rounded to the same size as the drilled hole in the two plates. Each octagon shaped protrusion/ridge is put into a lathe where the extra length is rounded to match the drilled holes and placed into the plate and secured by welding.

The placement of the comb. Since the actual foundation that every beekeeper is using already has a design started with the octagon shape, it may be difficult for every frame to be perfectly aligned. Thus, in some embodiments corresponding octagon cells in each plate touch each other when the comb forming device 120 is in the closed or operative position. However, in other embodiments, corresponding octagon cells in each plate come close to each other but do not touch each other when the comb forming device 120 is in the closed or operative position.

The depth and width can be altered to accommodate any size comb needed. By changing the plates inside the device, we can make any size comb needed. The plates are made with the perfect size octagon shapes and depth with the desired number of cells. This device can be used in a deep, medium, or super or any other size frame being used. This device is designed to fill both sides of the frame at the same time. If the beekeeper for whatever reason they can just fill one side just by keeping the hoses on one side closed during the making of comb. In various embodiments, less vacuum may be applied so as to allow gravity to receive and distribute the wax within the device 120, though this will take longer.

When the frame FRAME is inserted into the opening of this device 120, both sides of the (Honeybee frame comb maker) are forced tight onto the frame which will cause a tight seal, with a turning or levering or any system method. The two plates PLATE-1 and PLATE-2 are of substantially identical sizes and are mounted together, inner face or surface to inner face or surface as described above. The protruding octagon shapes are mounted to both sides with a desired size and depth of the comb. Both sides of the device have the corresponding correct number of protruding parts with the exact size and spacing. Using one of the desired size comb models attached to each plate. The model is at small downward angle, illustratively a 13-degree downward angle which will leave the comb at the 13-degree upward angle. The angle may be adjusted up or down as desired, though it is noted that honeybees generally build comb cells at a 13-degree angle and it is suggested that the angle, comb size, comb shape, and so on should be appropriate for the particular bees or beehive.

When a frame FRAME such as having a smooth plastic edge or with a plastic foundation that has the started shape comb already is inserted into the comb maker, the two sides are equally pressed onto the plastic foundation and will make a tight seal. Once the seal or seals are made one or more (illustratively two) tubes on one or both sides of the device 120 impart a vacuum pressure to the device 120 interior.

A gauge may be mounted to measure the vacuum pressure. Once the vacuum level is sufficient to draw in the wax, the shut off on each tube is turned to the off position to keep the vacuum. On the other side of the comb maker two hoses or pipes attached to each side of the device. When the wax is melted (i.e., above a melting indicative temperature), the two shut offs are opened and the vacuum forces the melted wax into vacuumed area this will cause the melted wax to fill the space around the octagon protruding, same size and shape of the comb and the desired size comb is made. Once the wax has cooled enough the comb maker is removed. Now the frame with the fully structured comb is ready to be inserted into any hive and the bees can start to work. Any further wax work needed the bees will do with little consumed honey to complete the comb to their liking. Since most of the comb is already started. This is due to different size cells are used for different purposes.

Also, a very popular product today is when the comb and honey is put into a jar for sale and my device can be made to keep in prospective the size needed and can be cut east and precise. One size cell is for the brood which is for the (new eggs) that is attended to until the cell is capped, and the female adults emerge. Drones which are the males, those cells must be larger because Drones are the largest other than the queen bee. The QUEEN is the most important bee in the hive and only one Queen to a hive. They make her cell the biggest and feed her with the royal jelly. The other size is for the honey which is deeper to hold more honey. The device will have every cell at the 13-degree up word angel direction. This is to hold honey and the food for the bees from dripping out. The device is designed to not fill to the edge so the bees can have a natural walking path. The device has multiple inserts, only one device needed the plates can be changed out to accommodate Any size comb is needed. The non provisional will have all the sizes on all the drawings to back up the design.

Advantageously, the various embodiments enable the formation of a comb within a frame without a foundation. As such, a comb of any size or having any size cells or having any size cell spacing may be formed, such as the exact size and spacing used by a particular hive as if the bees of that hive had constructed it themselves.

Advantageously, the various embodiments enable beekeepers to gain efficiencies by reducing the amount of time needed by bees within a hive to make a comb, thereby enabling the bees to spend more time performing other valuable activities (e.g., gathering pollen, making honey, caring for larva and eggs, etc.). The bees will be able to gather and store more pollen and honey, leading to an increased amount of honey to be harvested.

Various modifications may be made to the systems, methods, apparatus, mechanisms, techniques, and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof.

What is claimed is:

1. A comb forming device, comprising:
a pair of plates of having substantially similar outer dimensions and having respective inner and outer surfaces, wherein the inner surfaces of the plates have formed thereon corresponding octagon shaped protrusions of one or more selected sizes; and
a closure mechanism for holding the plates together in an operative position, the operative position comprising the plates compressing therebetween a frame;
at least one of the plates having one or more first apertures configured to receive therethrough melted wax to be conveyed to a space formed between the plates in the operative position;
at least one of the plates having one or more second apertures configured to enable a vacuum pump attached thereto to remove therethrough air from the space formed between the plates in the operative position, the vacuum pressure configured to urge the distribution of was throughout the space formed between the plates and in accordance with the octagon shaped protrusions of the inner surfaces of the plates to form thereby a comb structure.

2. The comb forming device of claim 1, wherein upon separation of the plates from the operative position yields a comb structure formed within the frame.

3. The comb forming device of claim 1, wherein the plates are made of metal.

4. The comb forming plates of claim 2, wherein the plates are heated prior to separation by one or more heating devices.
